(19) United States
(12) Patent Application Publication
(10) Pub. No.: US 2025/0172018 A1
(43) Pub. Date: May 29, 2025

(54) Security Lock for Poles and Rods

(71) Applicant: LSAN Holdings LLC, Tampa, FL (US)

(72) Inventors: Daniel Hater, Tampa, FL (US); William Gustin, Tampa, FL (US)

(21) Appl. No.: 18/961,916

(22) Filed: Nov. 27, 2024

Related U.S. Application Data
(60) Provisional application No. 63/604,008, filed on Nov. 29, 2023.

(51) Int. Cl. E05B 73/00

(52) U.S. Cl. CPC E05B 73/0005

(57) ABSTRACT

A locking device, having a first lock arm having a retaining ring and a second lock arm, the first lock arm rotatably coupled to the second lock arm; a pin, the pin rotatably coupled to the second lock arm; a lever having a first end and a second end, the first end of the lever rotatably coupled to the pin; and in an unlocked state the second end of the lever is external to the retaining ring and in a locked state the second end of the lever is within the retaining ring.

### CROSS-REFERENCE TO RELATED APPLICATIONS

This application claims priority to U.S. Provisional Patent Application No. 63/604,008 filed Nov. 29, 2023, the disclosures of which is hereby incorporated by reference in its entirety.

### BACKGROUND

### Background of the Disclosure

The disclosure relates generally to a locking mechanism, and more particularly, to a locking mechanism configured to lock and secure fishing rods and other cylindrical objects like poles, rods, handles, and bars.

### Description of Related Art

Items that lack attachment points pose a challenge for security, making it difficult or even impossible to safeguard them using locks or security cables. For instance, cylindrical objects, like bars, poles, fishing poles, and kayak paddles, typically lack secure attachment points to attach a lock or secure with a security cable. Consequently, when left unattended, these items are vulnerable to theft. Currently, there is no device available on the market that can (1) be attached to items lacking secure attachment points without modifying the item, (2) lock onto the item, (3) provide a secure attachment point on the item, and (4) simultaneously lock multiple similar items to one another. This highlights the need for a locking device capable of securing items such as poles, rods, and other cylindrical objects.

The disclosed security systems and anti-theft devices and apparatus can be used for objects lacking suitable attachment points for locks or security cables. The disclosed system and apparatus can be used for attaching a cable lock to cylindrical objects like poles, rods, handles, and bars. The disclosed system and apparatus can be used to secure items with circular or cylindrical shapes, including fishing poles and kayak paddles.

### SUMMARY

The following description is exemplary and does not intend to limit the scope, application, or uses of any disclosed invention. While the description facilitates the implementation of the inventions by individuals skilled in the art, specific examples are provided without restrictive intent. It is evident to one skilled in the art that various modifications falling within the scope of the appended claims are possible. The present disclosure should not be confined to the disclosed embodiments, whether in the examples or elsewhere in this document.

In an embodiment, a locking device includes a first lock arm having a retaining ring and a second lock arm, the first lock arm rotatably coupled to the second lock arm; a pin, the pin rotatably coupled to the second lock arm; a lever having a first end and a second end, the first end of the lever rotatably coupled to the pin; and where in an unlocked state the second end of the lever is external to the retaining ring and in a locked state the second end of the lever is within the retaining ring.

In an alternative embodiment, the first end of the lever is slideably fixed to the pin.

In an alternative embodiment, the first lock arm further comprises a two-pronged attachment point for releasably fixing to the pin.

In an alternative embodiment, the retaining ring further comprises a channel.

In an alternative embodiment, in the locked state, the second end of the lever is within the channel.

In an alternative embodiment, the retaining ring is configured to receive a cable.

In an alternative embodiment, the locking device further includes a rubber lining, the rubber lining fixed to a side of the first lock arm and a side of the second lock arm.

In another embodiment, the locking device includes: a rounded first lock arm and a second rounded lock arm, the rounded first lock arm rotatably coupled to the rounded second lock arm forming an opening; a pin, the pin rotatably coupled to the rounded second lock arm; and a rounded lever rotatably coupled to the pin, the rounded lever shaped to align with an outer surface of the rounded first lock arm.

In an alternative embodiment, the locking device further includes the rounded first lock arm further includes a retaining ring.

In an alternative embodiment, the locking device may include that in an unlocked state a second end of the rounded lever is external to the retaining ring and in a locked state the second end of the rounded lever is within the retaining ring.

In an alternative embodiment, the retaining ring further includes a channel.

In an alternative embodiment, in the locked state, the second end of the rounded lever is within the channel.

In an alternative embodiment, the retaining ring is configured to receive a cable.

In an alternative embodiment, the locking device further includes a rubber lining, the rubber lining fixed to a side of the rounded first lock arm and a side of the rounded second lock arm.

In an alternative embodiment, a first end of the rounded lever is slideably fixed to the pin.

In an alternative embodiment, the rounded first lock arm further comprises an attachment point for releasably fixing to the pin, the attachment point at least partially surrounds the pin.

In an alternative embodiment, the locking device for locking a rod to a cable, includes: a first lock arm having a retaining ring and a second lock arm, the first lock arm rotatably coupled to the second lock arm; the retaining ring comprising a channel; a pin, the pin rotatably coupled to the second lock arm; a lever having a first end and a second end, the first end of the lever rotatably coupled to the pin; a rubber lining, the rubber lining fixed to a side of the first lock arm and a side of the second lock arm; and in an unlocked state the second end of the lever is external to the retaining ring and in a locked state the second end of the lever is within the channel such that a surface of the second end of the lever and a surface of the retaining ring are at least partially contacting the cable which prevents the transition from the locked state to the unlocked state.

In an alternative embodiment, the first lock arm further includes a two pronged attachment point for releasably fixing to the pin, the attachment point at least partially surrounds the pin.

In an alternative embodiment, the rubber lining at least partially contacts the fishing pole in the locked state.

In an alternative embodiment, the first end of the lever is slideably fixed to the pin.

### BRIEF DESCRIPTION OF THE DRAWINGS

FIG. 1 displays a side view and a cut away side view of an embodiment of the disclosed apparatus.

FIG. 2 displays an isometric transparent view of an embodiment of the disclosed apparatus.

FIG. 3 displays multiple side views of an embodiment of the disclosed apparatus.

FIG. 4 displays a side view of an embodiment of the disclosed apparatus.

FIG. 5 displays a side view an embodiment of the disclosed apparatus.

FIG. 6 displays a side view an embodiment of the disclosed apparatus.

FIG. 7 displays a side view an embodiment of the disclosed apparatus.

FIG. 8 displays a side view an embodiment of the disclosed apparatus in motion.

FIG. 9 displays an isometric view an embodiment of the disclosed apparatus.

FIG. 10 displays an isometric view an embodiment of the disclosed apparatus attached to a paddle.

FIG. 11 displays an isometric view an embodiment of the disclosed apparatus attached to a pole.

FIG. 12 displays an isometric view an embodiment of the disclosed apparatus attached to a fishing pole.

FIG. 13 displays an isometric view an embodiment of the disclosed apparatus attached to a pole with a cable.

While the presently described apparatus has been described in terms of the above examples and detailed description, those of ordinary skill will understand that alterations may be made within the spirit of the disclosed system or apparatus. It is to be understood that the presently described apparatus may assume various alternative variations and step sequences, except where expressly specified to the contrary. It is also to be understood that the specific devices and processes illustrated in the attached drawings and described in the specification are simply exemplary embodiments or aspects of the disclosed system or apparatus. Although the presently described apparatus has been described in detail for the purpose of illustration based on what is currently considered to be the most practical and preferred embodiments or aspects, it is to be understood that such detail is solely for that purpose and that the system or apparatus is not limited to the disclosed embodiments or aspects, but, on the contrary, is intended to cover modifications and equivalent arrangements that are within the spirit and scope thereof. For example, it is to be understood that the presently described apparatus contemplates that to the extent possible, one or more features of any embodiment or aspect can be combined with one or more features of any other embodiment or aspect.

### DETAILED DESCRIPTION

The present disclosure pertains to an apparatus designed to attach and lock onto items lacking secure attachment points. This apparatus is adjustable, allowing it to accommodate items of varying diameters. When clamped onto the target item, the apparatus creates an attachment point that can be used for securing a security cable or lock. The use of the disclosed apparatus is not limited solely to fishing rods, and phrases such as “rod” or “pole” are used to encompass a broader range of cylindrical objects.

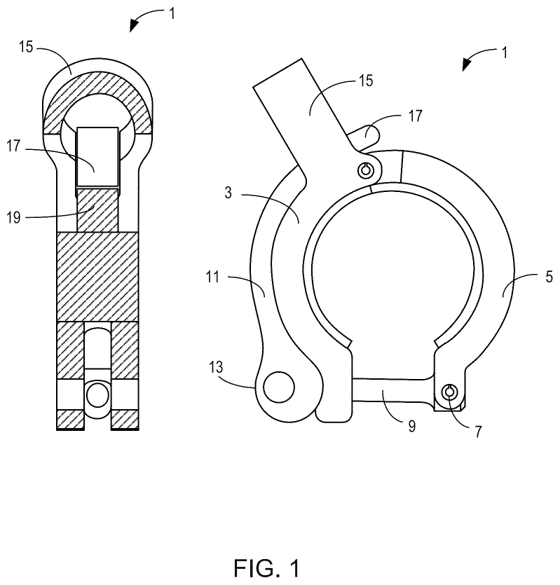

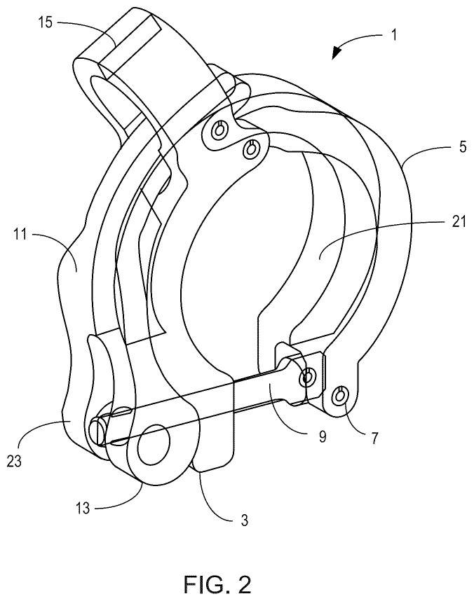

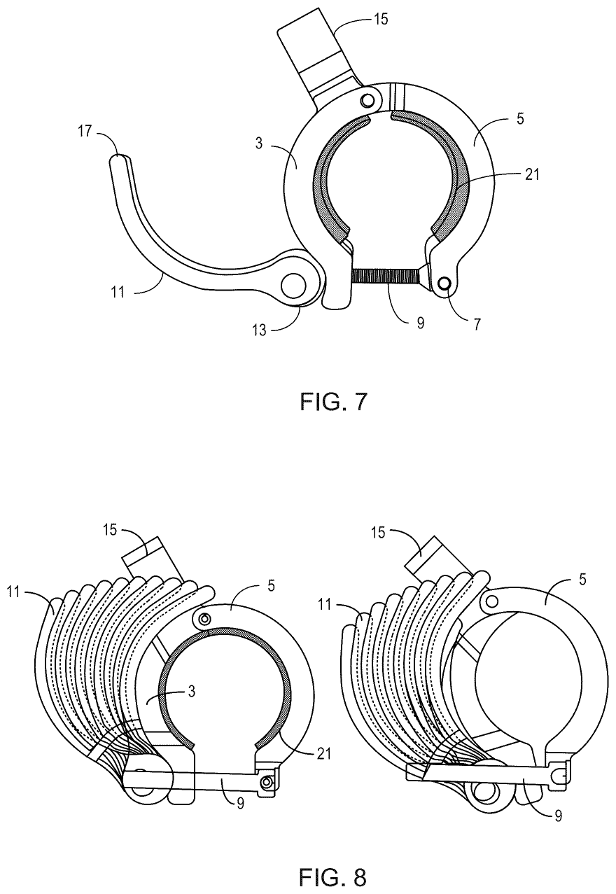

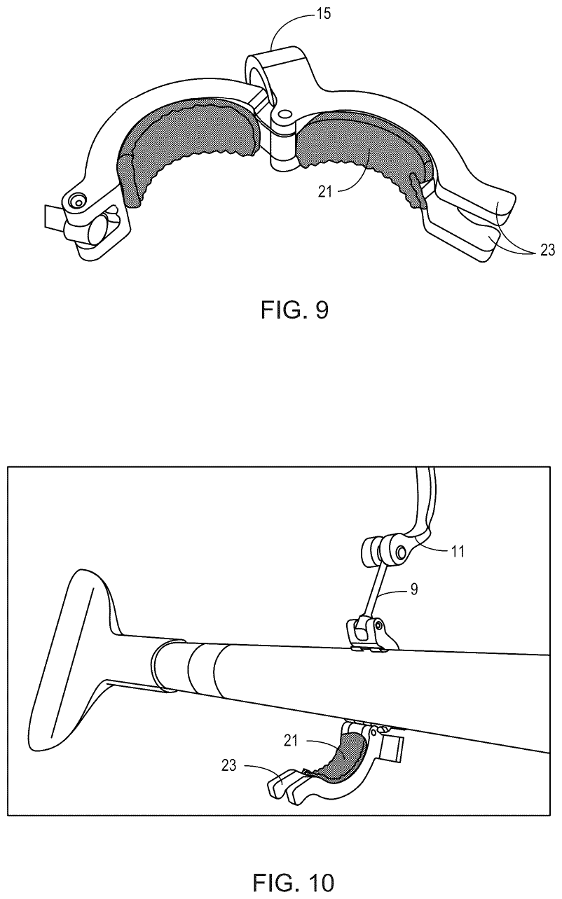

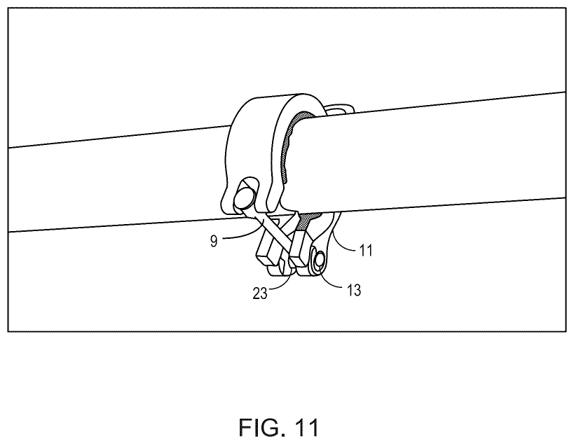

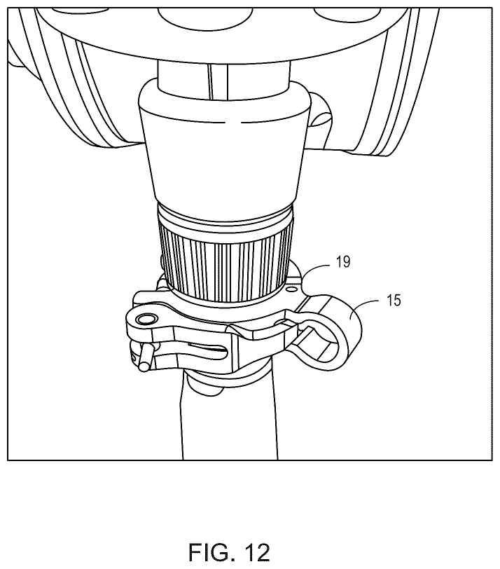

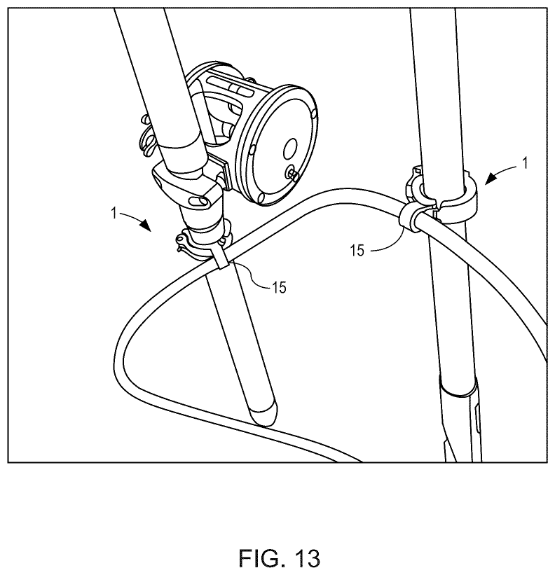

As shown in FIGS. 1-12, an exemplary locking device 1 is shown. The locking device 1 may include a first lock arm 3 and a second lock arm 5 coupled to one another. The first lock arm 3 and second lock arm 5 are preferably rounded in shape such that when fixed, they form a circular shape. The first locking arm 3 and second locking arm 5 are preferably coupled with an attachment pin 7, although first locking arm 3 and second locking arm 5 may be coupled in any way that allows for rotation, such that the first locking arm 3 and second locking arm 5 may rotate about the attachment pin 7 or each other.

The locking device 1 further includes a pin 9 coupled to the second lock arm 5. The pin 9 is preferably tubular, but while the term tubular is used herein, the cross section is not limited to any particular shape, circular or otherwise. The pin 9 is rotatably coupled to the second lock arm 5 such that the pin 9 may rotate about the attachment point. The pin 9 is further rotatably and slideably coupled to a lever 11 at a first end 13 of the lever 11. The connection point of the lever 11 and pin 9 allows for the connection point to be moveable along an axis of the pin 9, as shown in FIGS. 6 and 8. This advantageously allows for the locking device to lock onto a variety of diameters.

The connection of the pin 9 to the lever 11 further may be off centered from a central portion of the first end 13 to allow for the lever 11 and first lock arm 3 to adjust and reduce the circumference or diameter of the circular shape formed by the first lock arm 3 and second lock arm 5. This advantageously allows for the locking device to lock onto a variety of diameters. The lever 11 may be any shape but is preferably rounded like the first lock arm 3 such that the lever 11 may sit flush against an outer surface 13 of the first lock arm 3.

As shown in FIGS. 1-12, the first lock arm 3 may include a retaining ring 15 connected to the first lock arm 3. While FIGS. 1-12 show the retaining ring 15 fixed to an end of the first lock arm 3, the retaining ring 15 may be fixed to any point along the first lock arm 3 or second lock arm 5. The retaining ring 15 may extend outward from the center of the locking device 1. The retaining ring 15 is preferably circular in shape but may be any shape that allows for a second end 17 of the lever 11 to pass through. The retaining ring 15 may further include a channel 19 which is shaped to receive the second end 17 of the lever 11. The channel 19 may be embedded within the retaining ring 15 and/or within the first lock arm 3. The retaining ring 15 preferably includes a diameter and shape sized to receive a cable.

As shown in FIGS. 1-12, an internal surface of the first lock arm 3 and an internal surface of the second lock arm 5 may include a lining 21. The lining 21 may be any texture or pattern and any material that forms an anti-slip lining on the interior surfaces of the first lock arm 3 and second lock arm 5. Preferably the lining 21 is a high-density, anti-slip rubber lining. Advantageously, the lining 21 prevents damage to the secured item or rod and allows the locking device 1 to grip the secured item or rod to prevent the locking device 1 from sliding off the secured item or rod.

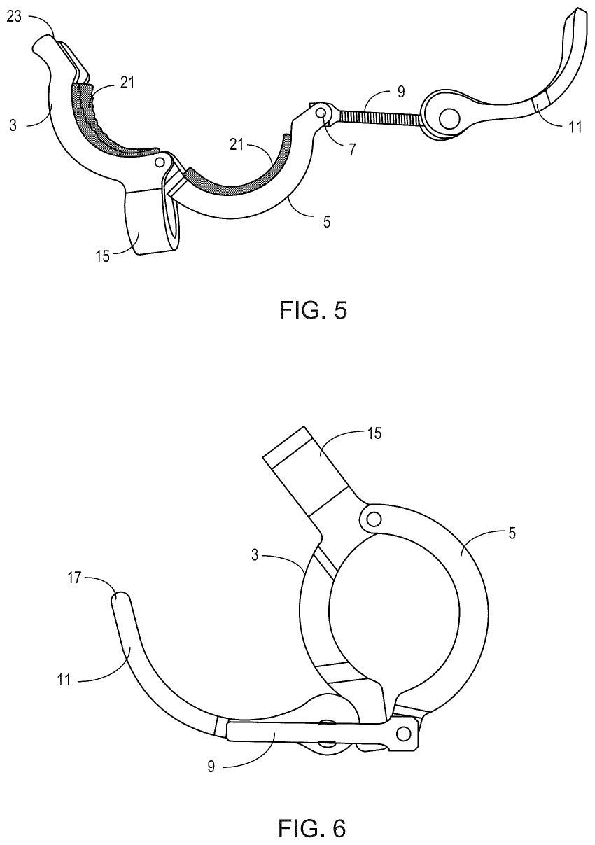

An unlocked state of the locking device 1 is shown in FIGS. 5-7. The unlocked state of the locking device 1 includes the lever 11 being outside of the retaining ring 15. While in the unlocked state, the locking device 1 allows for rotation along all or some of the hinges and attachment points. During the unlocked state, a user may insert a pole or item along the internal surface of the first lock arm 3 and second lock arm 5 to contact at least a portion of the lining 21. A user may then rotate or wrap the locking device 1 around the pole or item such that the lining 21 is further contacting the pole or item or the first lock arm 3 and second lock arm 5 at least partially surrounds the pole or item. The pin 9 may then be rotated such that the lever 11 contacts the attachment point 23 of an end of the first lock arm 3. The attachment point may be any shape but is preferably a two-pronged extending arm which at least partially surrounds the pin 9.

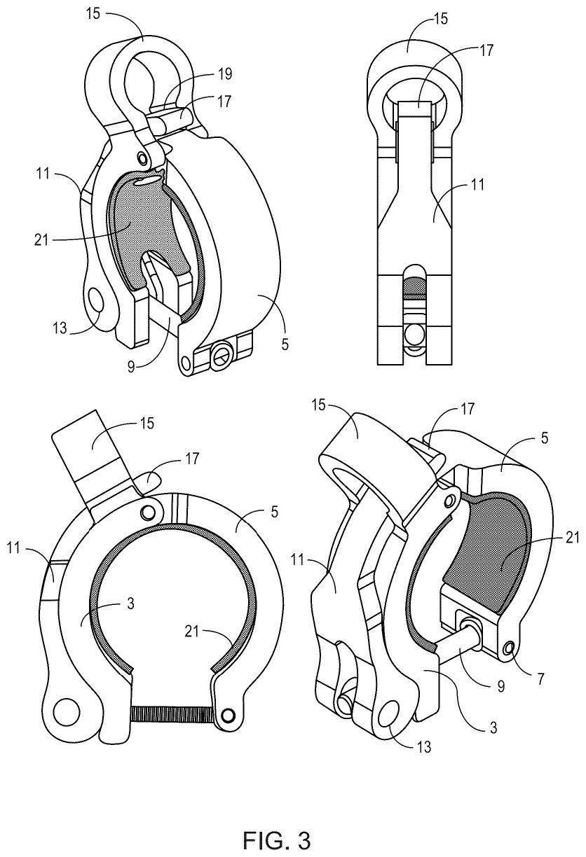

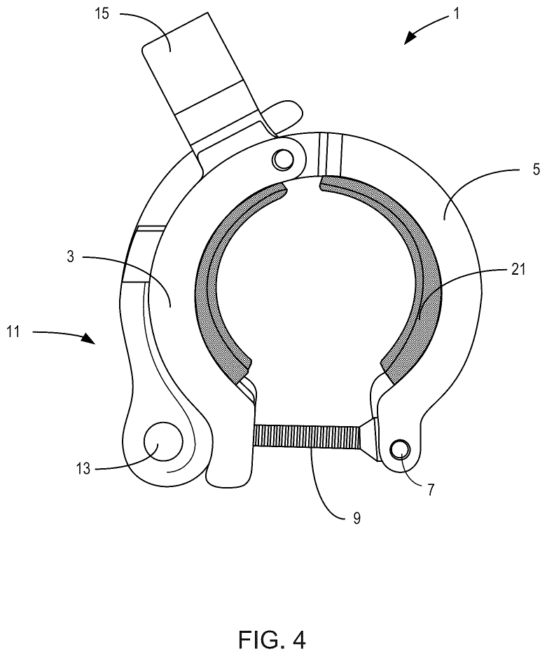

The lever 11 may be rotated to enter the retaining ring 15 and contact the outer surface of the first lock arm 3. Preferably the level 11 sits flush against the first lock arm 3 in a locked state. The locked state is shown in at least FIGS. 3 and 4. The locked state of the locking device 1 forms a circle like shape or area with the lining 21 contacting the pole or item. In the locked state, the lever 11 is flush against the first lock arm 3 and the lever 11 extends through the retaining ring 15. Preferably, the second end 17 of the lever 11 extends through the retaining ring 15 and is seated within the channel 19. While the second end 17 of the lever 11 is seated within the channel 19, the retaining ring 15 may allow for a cable to be extended through. Advantageously, with a cable extended through the channel 19, the locking device 1 may not be transferred from the locked state to an unlocked state.

The retaining ring 15 may be configured hold the lever 11 in place when in the locked state and provides a passage for a security cable. When a security cable is passed through the retaining ring 15, the cable prevents the lever 11 from being released, thereby locking the locking device 1 to the pole or rod. The cable passed through the retaining ring 15 locks the lever 11 in place so that the locking device 1 is closed and locked onto the pole or rod.

This apparatus operates as a “coupling system” as it works with a security cable to both lock the apparatus to the secured item and secure the secured item to a stationary object. In other words, the disclosed apparatus enables the coupling of a security cable to a pole or rod that lacks any attachment point.

What is claimed is:

1. A locking device, comprising:
a first lock arm having a retaining ring and a second lock arm, the first lock arm rotatably coupled to the second lock arm;
a pin, the pin rotatably coupled to the second lock arm;
a lever having a first end and a second end, the first end of the lever rotatably coupled to the pin; and
wherein in an unlocked state the second end of the lever is external to the retaining ring and in a locked state the second end of the lever is within the retaining ring.

2. The locking device of claim 1, wherein the first end of the lever is slideably fixed to the pin.

3. The locking device of claim 1, wherein the first lock arm further comprises a two-pronged attachment point for releasably fixing to the pin.

4. The locking device of claim 1, wherein the retaining ring further comprises a channel.

5. The locking device of claim 4, wherein in the locked state, the second end of the lever is within the channel.

6. The locking device of claim 1, wherein the retaining ring is configured to receive a cable.

7. The locking device of claim 1, further comprising a rubber lining, the rubber lining fixed to a side of the first lock arm and a side of the second lock arm.

8. A locking device, comprising:
a rounded first lock arm and a rounded second lock arm, the rounded first lock arm rotatably coupled to the rounded second lock arm forming an opening;
a pin, the pin rotatably coupled to the rounded second lock arm; and
a rounded lever rotatably coupled to the pin, the rounded lever shaped to align with an outer surface of the rounded first lock arm.

9. The locking device of claim 8, wherein the rounded first lock arm further comprises a retaining ring.

10. The locking device of claim 9, wherein in an unlocked state a second end of the rounded lever is external to the retaining ring and in a locked state the second end of the rounded lever is within the retaining ring.

11. The locking device of claim 10, wherein the retaining ring further comprises a channel.

12. The locking device of claim 11, wherein in the locked state, the second end of the rounded lever is within the channel.

13. The locking device of claim 9, wherein the retaining ring is configured to receive a cable.

14. The locking device of claim 8, further comprising a rubber lining, the rubber lining fixed to a side of the rounded first lock arm and a side of the rounded second lock arm.

15. The locking device of claim 8, wherein a first end of the rounded lever is slideably fixed to the pin.

16. The locking device of claim 8, wherein the rounded first lock arm further comprises an attachment point for releasably fixing to the pin, the attachment point at least partially surrounds the pin.

17. A locking device for locking a rod to a cable, comprising:
a first lock arm having a retaining ring and a second lock arm, the first lock arm rotatably coupled to the second lock arm;
the retaining ring comprising a channel;
a pin, the pin rotatably coupled to the second lock arm;
a lever having a first end and a second end, the first end of the lever rotatably coupled to the pin;
a rubber lining, the rubber lining fixed to a side of the first lock arm and a side of the second lock arm; and
wherein in an unlocked state the second end of the lever is external to the retaining ring and in a locked state the second end of the lever is within the channel such that a surface of the second end of the lever and a surface of the retaining ring are at least partially contacting the cable which prevents the transition from the locked state to the unlocked state.

18. The locking device of claim 17, wherein the first lock arm further comprises a two-pronged attachment point for releasably fixing to the pin, the attachment point at least partially surrounds the pin.

19. The locking device of claim 17, wherein the rubber lining at least partially contacts the fishing pole in the locked state.

20. The locking device of claim 17, wherein the first end of the lever is slideably fixed to the pin.
